(19) United States
(12) Patent Application Publication
(10) Pub. No.: US 2020/0359762 A1
(43) Pub. Date: Nov. 19, 2020

(54) LUMINOUS HAIR ACCESSORY

(71) Applicant: Stephanie Chang, HERNDON, VA (US)

(72) Inventor: Stephanie Chang, HERNDON, VA (US)

(21) Appl. No.: 16/441,481

(22) Filed: Jun. 14, 2019

Related U.S. Application Data
(60) Provisional application No. 62/847,350, filed on May 14, 2019.

(51) Int. Cl. A45D 8/28; F21V 8/00

(52) U.S. Cl. CPC A45D 8/28; A45D 2008/004; G02B 6/0001

(57) ABSTRACT

A luminous hair accessory is provided. The luminous hair accessory includes a light module and a main body for holding hair. At least a portion of the main body is made of light guide material and has a light entrance and a light extraction structure. A fixed light path from the light entrance to the light extraction structure is formed in the light guide material. The light module is coupled to the main body and configured to emit light to the light entrance on the main body. The light travels over the portion of the main body and is then extracted from the portion of the main body through the light extraction structure.

### CROSS-REFERENCE TO RELATED APPLICATIONS

The present application is a nonprovisional application claiming benefit from a prior-filed provisional application bearing a Ser. No. 62/847,350 and filed May 14, 2019, the entity of which is incorporated herein for reference.

### FIELD OF THE INVENTION

The present disclosure relates to a hair accessory, and more particularly to a luminous hair accessory.

### BACKGROUND OF THE INVENTION

Hair accessories are likely the most common articles carried with females. If additional function can be provided with the hair accessories, the applicability of the hair accessories is further enhanced.

### SUMMARY OF THE INVENTION

An aspect of the present disclosure provides a luminous hair accessory. The luminous hair accessory includes a light module and a main body for holding hair. At least a portion of the main body is made of light guide material and has a light entrance and a light extraction structure. A fixed light path from the light entrance to the light extraction structure is formed in the light guide material. The light module is coupled to the main body and configured to emit light to the light entrance on the main body. The light travels over the portion of the main body and is then extracted from the portion of the main body through the light extraction structure.

In an embodiment, the light guide material is polycarbonate, poly(methyl methacrylate), polystyrene, acrylonitrile butadiene styrene or a combination thereof. The light is guided in the light guide material by total internal reflection.

In an embodiment, the light extraction structure includes embossing, V-cutting groove(s) or micro dots formed by etching, injection molding or printing.

In an embodiment, a notch is formed on the portion of the main body to indicate the light entrance receiving the light from the light module.

In an embodiment, the light module is an internal light module to be embedded in the portion of the main body. The internal light module includes a resilient cover defining therein an accommodation space and having an opening connected to the accommodation space. A light source, a battery device and a push switch are disposed in the accommodation space. The light source is configured to emit the light. The battery device is configured to power the light source. The push switch is electrically connected between the light source and the battery device and disposed close to a touch surface of the resilient cover for switching on and off the light source in response to a pressing action on the touch surface.

In an embodiment, a positioning hole is formed on the portion of the main body for supporting the internal light module.

In an embodiment, the light module is an external light module detachably coupled to the main body. The external light module includes a deformable cover defining therein an accommodation space and having an opening connected to the accommodation space. A portion of the deformable cover deforms in response to a pressing action. A securing member is formed on the deformable cover to secure the external light module to the main body. A light source, a battery device and a push switch are disposed in the accommodation space. The light source is configured to emit the light. The battery device is configured to power the light source. The push switch is electrically connected between the light source and the battery device and disposed close to the deformed portion of the deformable cover for switching on and off the light source in response to the pressing action.

In an embodiment, the main body includes two handle portions pivotally coupled to each other and the external light module is secured between the two handle portions. The external light module is switched on or off when the handle portions are pressed together in response to the pressing action to open the main body to receive or relieve the hair and squeeze the external light module.

In an embodiment, the securing member is an elastic catch loop formed on a lateral surface of the deformable cover. The external light module is secured to the main body by fitting the elastic catch loop to one of the handle portions. A groove is formed on the handle portion to accommodate a portion of the elastic catch loop when the elastic catch loop is fit to the handle portion to secure the external light module to the main body.

In an embodiment, the pressing action is directly performed on the deformed portion of the deformable cover.

In an embodiment, the securing member is a hook and a corresponding catch, a hook and loop fastener or a magnet pair.

In an embodiment, the main body includes a hair-sectioning piece to be inserted into hair; and a hair-clamping piece pivotally coupled to the hair-sectioning piece for cooperating with the hair-sectioning piece for clamping a bundle of hair. The hair-clamping piece is integrally formed and made of the light guide material. The hair-clamping piece has the light entrance and the light extraction structure. The light emitted from the light module enters the hair-clamping piece through the light entrance and is extracted from the hair-clamping piece through the light extraction structure.

In an embodiment, the hair-sectioning piece is integrally formed and made of the light guide material. The hair-sectioning piece has another light entrance and another light extraction structure. The light emitted from the light module enters the hair-sectioning piece through the corresponding light entrance and is extracted from the hair-sectioning piece through the corresponding light extraction structure.

In an embodiment, the main body includes a first clamping piece integrally formed and made of the light guide material and has a first light entrance and a first light extraction structure; and a second clamping piece integrally formed and made of the light guide material and has a second light entrance and a second light extraction structure. The second clamping piece is pivotally coupled to and cooperates with the first clamping piece for clamping a bundle of hair. First light emitted from the light module enters the first clamping piece through the first light entrance and is extracted from the first clamping piece through the first light extraction structure. Second light emitted from the light module enters the second clamping piece through the second light entrance and is extracted from the second clamping piece through the second light extraction structure.

In an embodiment, the main body includes a decorative portion not covered by the hair and has thereon at least one positioning hole for supporting at least one light module in a one-to-one manner.

In an embodiment, the main body has a form of a hair clip, an alligator hair clip, an arch clip, a butterfly hair clip, a claw clip, a barrette clip, a headband, a teeth comb, hairband, a ponytail barrette, an updo barrette, a tortoise shell barrette, a hair comb, a hair stick or a hair tie cuff.

### BRIEF DESCRIPTION OF THE DRAWINGS

The above objects and advantages of the present disclosure will become more readily apparent to those ordinarily skilled in the art after reviewing the following detailed description and accompanying drawings, in which:

FIGS. 1A and 1B are schematic diagram illustrating luminous hair accessories according to embodiments of the present disclosure;

FIG. 2 is a schematic diagram showing the light module of the luminous hair accessory and the internal circuit thereof;

FIG. 3A is a schematic diagram illustrating a luminous hair accessory according to another embodiment of the present disclosure;

FIG. 3B is a schematic diagram showing another light module of the luminous hair accessory and the internal circuit thereof;

FIG. 4 is a schematic diagram illustrating a luminous hair accessory according to a further embodiment of the present disclosure;

FIG. 5 is a schematic diagram illustrating a luminous hair accessory according to a further embodiment of the present disclosure;

FIGS. 6A and 6B are schematic diagrams illustrating the appearance and internal circuit of the light module; and

FIGS. 7A-7D are schematic diagrams illustrating luminous hair accessories according to further embodiments of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

The present disclosure provides a luminous hair accessory. The luminous effect of the hair accessory can be activated at night for safety consideration. For example, riders or drivers of vehicles can notice the pedestrian or bicycle rider carrying the luminous hair accessory in subdued lighting or dark streets. Since the hair accessory is almost the necessary attachment to a woman or a girl, it is convenient for her to not carry or wear other luminous attachment with her. Furthermore, the hair accessory put at the height of one's head is easily noticed to effectively increase the safety of the wearer.

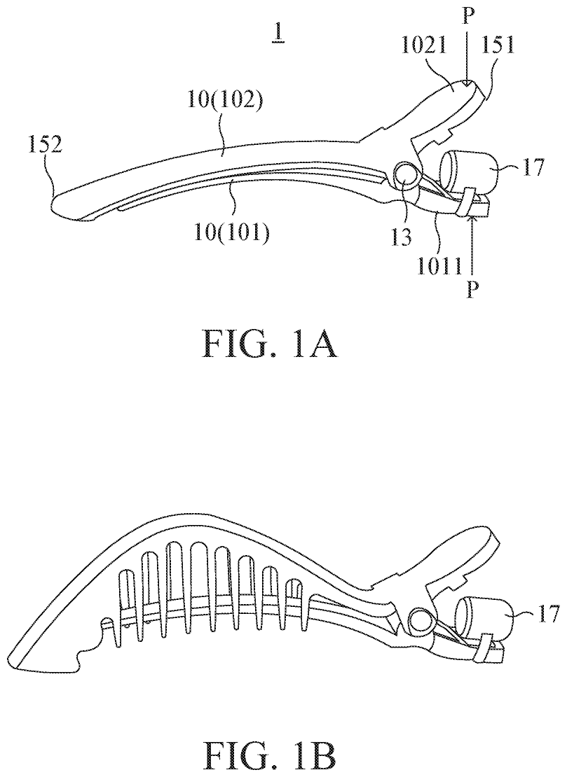

Please refer to FIG. 1A, which is a schematic diagram illustrating a hair accessory according to an embodiment of the present disclosure. The hair accessory is provided in the form of a hair clip 1. The hair clip 1 includes a main body 10. The main body 10 includes a hair-sectioning piece 101 to be inserted into hair for gathering a bundle of hair (not shown), and a hair-clamping piece 102 pivotally coupled to and cooperating with the hair-sectioning piece 101 for clamping the bundle of hair. Therefore, while in use, the hair-clamping piece 102 of the hair clip 1 is laid over the hair without being covered.

The hair-sectioning piece 101 and the hair-clamping piece 102 are coupled at a pivot point 13 near a tail end 151 of the main body 10. The hair-sectioning piece 101 and the hair-clamping piece 102 form handle portions 1011 and 1021 between the pivot point 13 and the tail end 151 of the main body 10. A coil spring (not shown) is mounted around the pivot point 13 and connected to the hair-sectioning piece 101 and the hair-clamping piece 102 at two ends to push against the two pieces 101 and 102 to provide elastic force for closing the main body 10. By pressing the handle portions 1011 and 1021 together, the elastic force is canceled out to make the main body 10 opened for receiving the bundle of hair. Then, after releasing the pressing force P on the handle portions 1011 and 1021, the main body 10 is closed due to the elastic force for clamping and holding the bundle of hair.

The main body 10 includes at least a rigid portion for providing the luminous effect. For example, at least the hair-clamping piece 102 of the main body 10 of the hair clip 1 is rigid and made of transparent material, especially light guide material. A light module 17 is disposed between the handle portions 1011 and 1021. The light module 17 can emit light toward the handle portion 1021 of the hair-clamping piece 102. Then, the light is guided in the hair-clamping piece 102 from the tail end 151 to the head end 152. The light is spread out through surfaces of the hair-clamping piece 102 and thus can be seen and noticed.

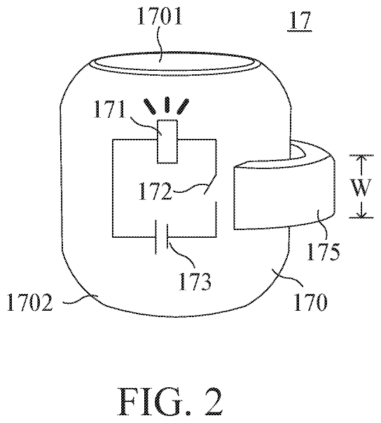

The light module 17 is activated or deactivated by pressing the handle portions 1011 and 1021 together to switch on or switch off the light module 17. FIG. 2 schematically shows the light module 17. The light module 17 has a deformable cover 170 made of soft material, e.g. silicon rubber. While pressing the handle portions 1011 and 1021 together, the soft cover 170 is squeezed and thus deforms along the pressing direction. An accommodation space (not shown) is defined by the soft cover 170 having a top opening 1701 connected to the accommodation space. A focused light source 171 (e.g. light-emitting diode (LED)), a push switch 172 and a battery device 173 are disposed in the accommodation space. The light source 171 is electrically connected to and controlled by the push switch 172 and powered by the battery device 173. The battery device 173 may be a primary battery or a rechargeable battery to meet real conditions. In addition, the light module 17 has a securing member for securing the light module 17 to the main body 10. For example, an elastic catch loop 175 is provided on a lateral surface of the soft cover 170. The elastic catch loop 175 may be disposed near the top opening 1701, disposed near the bottom 1702 (opposite to the top opening 1701) of the soft cover 170, or disposed at a middle position between the top opening 1701 and the bottom 1702. The light module 17 could be attached to or detached from the handle portion 1011 or 1021. By fitting the elastic catch loop 175 to the handle portion 1011 or 1021, the light module 17 is fixed between the handle portions 1011 and 1021. The width W of the elastic catch loop 175 may be modified to firmly couple the light module 17 to the handle portion 1011 or 1021. In addition, a groove (not shown) may be provided on the handle portion 1011 or 1021 to accommodate a portion of the elastic catch loop 175 to assist positioning and fixing the light module 17. When the user presses the handle portions 1011 and 1021 together, a specific portion of the soft cover 170 corresponding to the position of the push switch 172 deforms, and the push switch 172 near or immediately adjacent to the soft cover 170 is closed to switch on the light source 171. The light of the light source 171 is emitted out through the top opening 1701 and transmitted to a light entrance (not shown) on the hair-clamping piece 102 along a specific direction (e.g. toward upper left in FIG. 1A). When the user presses the handle portions 1011 and 1021 together again, the push switch 172 is opened to switch off the light source 171. In other words, repetitive pressing actions will turn on and turn out the light in turn. In another embodiment, the push switch 172 may be a multi-stage push switch for cyclically controlling the brightness of the light. In another embodiment, a press region (e.g. on the bottom 1702) is provided on the soft cover 170 corresponding to the push switch 172 or a button (not shown) corresponding to the push switch 172 is exposed from the soft cover 170 for directly receiving users pressing actions so that the switching of the light source 171 is not affected by pressing the handle portions 1011 and 1021.

It is to be noted that any type of known securing member is applicable to the light module 17 and should be encompassed in the present disclosure. For example, at least one hook is mounted on the light module 17 and at least one corresponding catch is mounted on the back of the handle portion 1011 or 1021, and vice versa. The hook and the catch can fix the light module 17 to the handle portion 1011 or 1021 at the desired position and direction to make sure correct light path of the light source 171. In other embodiments, other securing members including a hook and loop fastener, a magnet pair and so on could be adopted in the present disclosure following the above-described concepts, and further description needs not be given here.

The light module 17 could be viewed as a replaceable part. For example, a first light module 17 having a red LED is fixed to the handle portion 1011 or 1021 to emit red light to the light entrance in a first situation; and a second light module 17 having a blue LED, in stead of the first light module 17, is fixed to the handle portion 1011 or 1021 to emit blue light to the light entrance in a second situation. The replaceability of the light module 17 can produce variety in the applications.

The light guide material for forming the hair-clamping piece 102 usually has higher refractive index (e.g. greater than 1.4) which are suitable to make successive total internal reflections in the hair-clamping piece 102. The light guide material may be, but not limited to, polycarbonate (PC), poly(methyl methacrylate) (PMMA), polystyrene (PS), acrylonitrile butadiene styrene (ABS) or a combination of them. The hair-clamping piece 102 may be integrally formed to prevent loss of light across gaps. The light is extracted through specific positions (light extraction structure) of the hair-clamping piece 102, e.g. positions at upper surface or lateral surface, by any know technology such as embossing, V-cutting groove, micro dots formed by etching, injection molding or printing with any desired pattern. For example, a specific optical pattern (e.g. brand name or trademark) can be shown as the light source is activated. The light extraction technology mainly changes the incident angle of the light to frustrate the total internal reflection to allow the light to escape the hair-clamping piece 102. The rigid portion made of the light guide material is solid, not flexible and does not deform at any time no matter whether the hair accessory is put on someone's head, taken off, lit on or lit off so that the light path from the light entrance to the light extraction structure keeps unchanged (i.e. a fixed light path is formed in the light guide material). Since the light path should be controlled, a mark (e.g. notch, not shown) is formed on the handle portion 1011 or 1021 to indicate the correct position (light entrance) to be aimed so that the user can properly mount the light module 17 to the handle portion 1011 or 1021. The groove on the handle portion 1011 or 1021 described in the foregoing is also advantageous to positioning of the light module 17 on the handle portion 1011 or 1021. Besides, such design could be also applied to the hair-sectioning piece 101, if necessary or desired, even though the hair-sectioning piece 101 is usually hidden behind hair. In this case, the top opening 1701 or additional opening (not shown) should further allow the light to be emitted to the handle portion 1011 of the hair-sectioning piece 101. The handle portions 1011 and 1021 may correspond to a single light source 171 or respective light sources with different colors controlled by a single push switch 172.

The luminous hair accessory of the present disclosure can enhance personal protection in subdued lighting or dark streets, and further enhance aesthetics. The operation of the light module 17 is easy and convenient, and the luminous effect can be activated or deactivated as one wishes. In contract to the reflective clothing, the luminous hair accessory of the present disclosure is still highly visible with little or without ambient light.

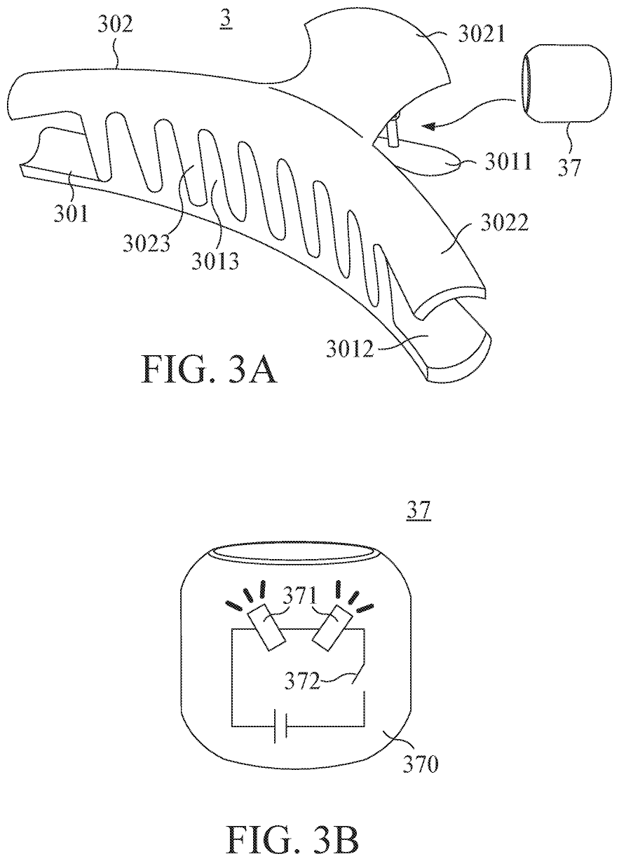

FIG. 1B shows another kind of a hair clip using the light module 17 in a similar way, and similar detailed description can be referred to the embodiment with reference to FIGS. 1A and 1s not further given herein. The present disclosure can be applied to other hair accessory having similar structure. For example, a butterfly hair clip or a claw clip including two clamping pieces 301 and 302 according to the present disclosure is shown in FIG. 3. Each clamping piece 301(302) includes a handle portion 3011 (3021), a palm portion 3012 (3022) and a claw portion 3013 (3023). The above-described light module 37 is fixed between the handle portions 3011 and 3021 with any know securing member (not shown). The two clamping pieces 301 and 302 are substantially symmetrical halves of the claw clip 3, and only the claw portions 3013 and 3023 are placed behind and covered by the hair. Therefore, it is better to provide respective light paths for both clamping pieces 301 and 302 to make sure that the light travels over the palm portions 3012 and 3022 (and the handle portions 3011 and 3021), which are especially easily noticed. FIG. 3B shows that two light sources 371 with the same or different colors are disposed in the deformable cover 370 and provided for the two clamping pieces 301 and 302, respectively. The two light sources 371 are controlled by a single push switch 372. In another embodiment, the light sources 371 are independently controlled by respective push switches (e.g. in the form of press regions or buttons as described above), and the modification to the circuit arrangement could be derived based on ordinary skill. Several or all of the features or design principles described in the above embodiments may be applied to the claw clip 3 without further description, and similar detailed description is not given herein.

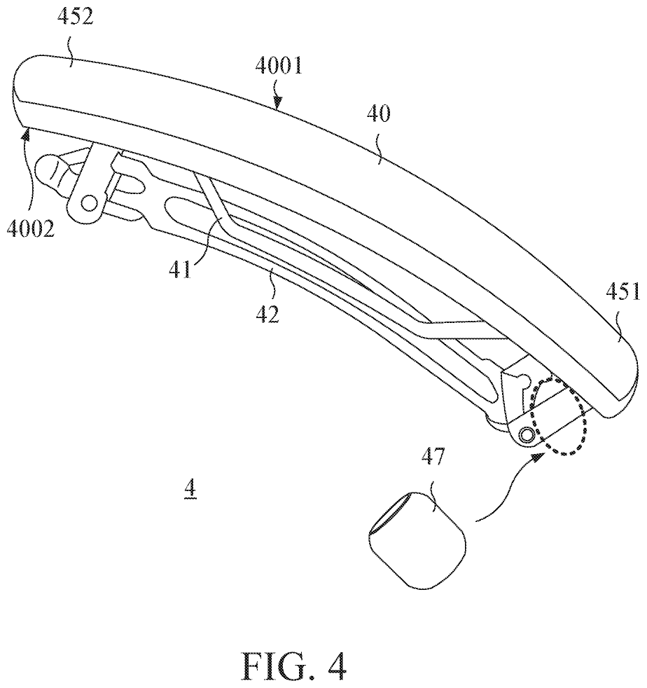

FIG. 4 shows that the light module is used with a barrette clip. The barrette clip 4 includes a decorative top 40, an upper elastic member 41 and a lower elastic member 42. The elastic members 41 and 42 are connected at a tail end 451, and operable to be connected or disconnected at a head end 452. When in use, hair enters the space confined by the elastic members 41 and 42 from a mouth at the disconnected end 452, and clamped between the elastic members 41 and 42 by connecting the elastic members 41 and 42 to close the mouth at the head end 452. Meanwhile, the elastic members 41 and 42 urge against each other in order to secure hair therebetween. At this time, the decorative top 40 is the most visible portion of the barrette clip 4. The above-described light module 47 is fixed to the back side of the decorative top 40 at the tail end 451 with any known securing member (not shown). In the embodiment, the decorative top 40 is viewed as the above-mentioned rigid portion and made of light guide material. The decorative top 40 has a light entrance located on the lower surface 4002 of the decorative top 40 for receiving the light emitted from the light module 47 and a light extraction structure covering the upper surface 4001 of the decorative top 40. Thus, the light travels over the decorative top 40, which is especially easily noticed.

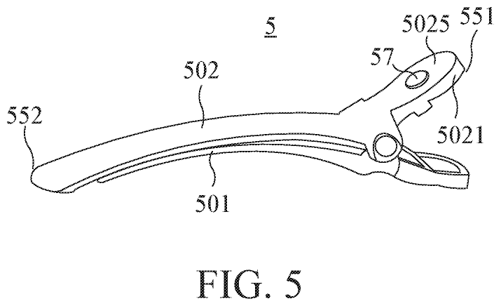

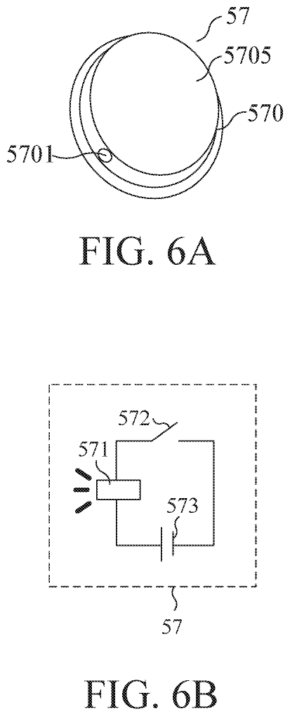

The external light module may be modified to be embedded in the hair accessory to reduce negative influence on the exterior appearance of the hair accessory. FIG. 5 shows a hair clip 5 with a light module 57 (FIG. 6A) embedded therein. In the drawing, the light module 57 is embedded in the handle portion 5021 of the hair-clamping piece 502. The light module 57 has a resilient cover 570 so that the light module 57 could be well fit in a positioning hole (not shown) formed on the handle portion 5021 for supporting the light module 57 after the light module 57 is squeezed into the positioning hole. A touch surface 5705 of the resilient cover 570 is substantially aligned with or slightly protrudes from the upper surface 5025 of the handle portion 5021 and could be viewed as a button. On the other hand, if the light module 57 is squeezed into the positioning hole formed on a lower surface (not shown), opposite to the upper surface 5025, of the handle portion 5021, the touch surface 5705 is substantially aligned with or slightly protrudes from the lower surface. An accommodation space (not shown) is defined by the resilient cover 570 having a lateral opening 5701 or a bottom opening (not shown) connected to the accommodation space. Please refer to both FIGS. 6A and 6B, a focused light source 571 (e.g. LED), a push switch 572 and a battery device 573 are disposed in the accommodation space. The light source 571 is electrically connected to and controlled by the push switch 572 and powered by the battery device 573. The battery device 573 may be a primary battery or a rechargeable battery to meet real conditions. Pressing the touch surface 5705 down to a certain depth can make the push switch 572 closed or open to switch on or off the light source 571. Repetitive pressing actions will turn on and turn out the light in turn. The light of the light source 571 is emitted out through the lateral/bottom opening 5701 and transmitted to the hair-clamping piece 502. A mark (e.g. notch, not shown) is formed on the inner wall or bottom surface of the positioning hole to indicate the correct position (light entrance) for receiving the incident light. To put the light module 57 into the positioning hole, the light beam should be aligned to center the mark. In another case, the push switch 572 may be a multi-stage push switch for cyclically controlling the brightness of the light. Similar to the external light module described above, the internal light module is also replaceable so that the luminous color of the hair clip 5 is changeable.

The detailed structure of the hair-sectioning piece 501 and the hair-clamping piece 502 is similar to those described with reference to FIG. 1A, and similar description is not given herein. It is to be noted that the number and the positions of the light modules 57 and the corresponding positioning holes are not limited. For example, two light modules 57 with different colors may be disposed near the tail end 551 and the head end 552, respectively, to provide blending colors with gradient effect in the hair-clamping piece 502. The light modules 57 are independently controlled so as to provide various visible effects. Also, two light modules 57 may be disposed in positioning holes, in a one-to-one manner, of the hair-sectioning piece 501 and the hair-clamping piece 502, respectively, and the user could decide to switch on one or two light modules 57 as desired. The internal light module 57 could be applied to the hair clip (alligator hair clip, arch clip, butterfly hair clip and claw clip) of FIG. 1B and FIG. 3A and the barrette clip of FIG. 4 in a similar manner, and similar description is not given again.

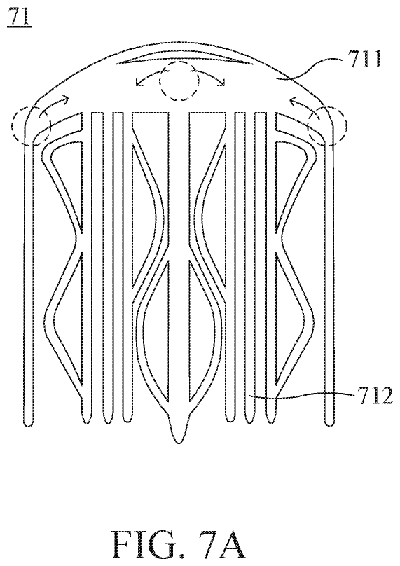

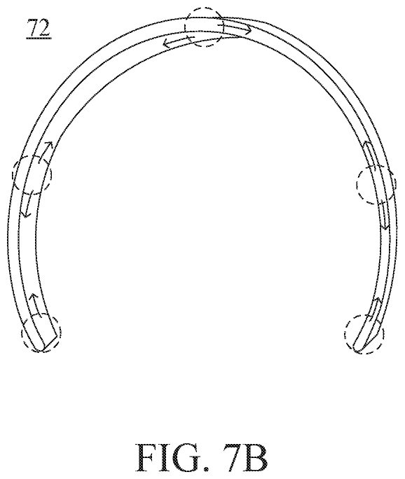

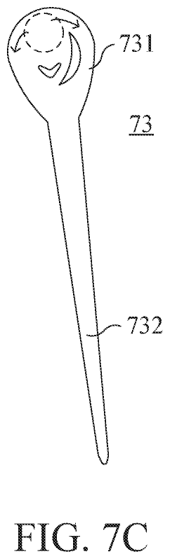

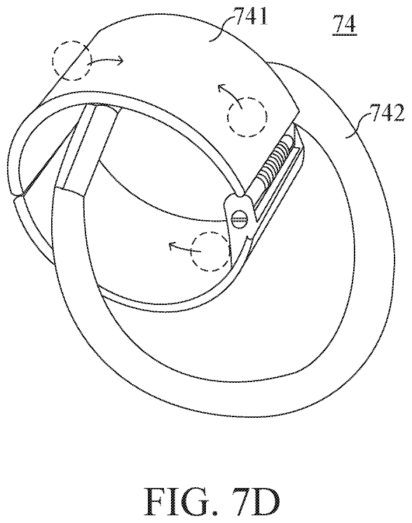

The concepts of the internal light module could be applied to various kinds of hair accessories, e.g. headband, teeth comb, hairband, ponytail barrette, updo barrette, tortoise shell barrette, hair comb, hair stick, hair tie cuff which has a rigid portion with or without resilience where a positioning hole is formed to accommodate the light module(s). The rigid portion is made of light guide material and processed with any known light extraction technology at desired positions. FIGS. 7A-7D illustrate several types of the luminous hair accessories. In FIG. 7A, the luminous hair accessory is in a form of a teeth comb 71 including a decorative head (rigid portion) 711 and a teeth structure 712. When in use, the decorative head 711 is visible over the hair and the teeth structure is hidden behind the hair. The dashed circles indicate practicable and possible positions of the light entrances or the internal light modules at the front side or the back side (not shown) of the decorative head 711, and the arrows indicate partial light paths in the decorative head 711, but they are not used to limit the precise form of the present disclosure. In FIG. 7B, the luminous hair accessory is in a form of a hairband 72. The hairband 72 itself could be viewed as the rigid portion. The dashed circles indicate practicable and possible positions of the light entrances or the internal light modules on the inner surface or the outer surface of the hairband 72, and the arrows indicate partial light paths in the hairband 72, but they are not used to limit the precise form of the present disclosure. In FIG. 7C, the luminous hair accessory is in a form of a hair stick 73 including a decorative head 731 and a stick structure 732. At least the decorative head 731 is viewed as the above-mentioned rigid portion. When in use, the decorative head 731 is visible over the hair and the stick structure 732 is inserted in a hair bun. The dashed circle indicates practicable and a possible position of the light entrance or the internal light module at the front side or the back side (not shown) of the decorative head 731, and the arrows indicate partial light paths in the decorative head 731, but they are not used to limit the precise form of the present disclosure. In FIG. 7D, the luminous hair accessory is in a form of a hair tie cuff 74 including a cuff (rigid portion) 741 and an elastic 742. The dashed circles indicate practicable and possible positions of the light entrances or the internal light modules on the inner surface or the outer surface of the cuff 741, and the arrows indicate partial light paths in the cuff 741, but they are not used to limit the precise form of the present disclosure. The structures of other types of the hair accessories are not particularly described herein, but the internal light modules could be designed or modified in structure, form, size or shape to fit the hair accessories by referring to the description in the foregoing. Such modifications are included in the present disclosure even though the precise forms are not given in detail.

In view of the foregoing, the present disclosure provides a luminous hair accessory having an internal or external light module. The colored light is guided in the hair accessory by total internal reflection and extracted through surfaces of the hair accessory. The internal or external light module is replaceable so as to enhance the flexibility and variety of the luminous effects of the luminous hair accessory. The luminous effect can be activated or deactivated as desired to enhance personal safety and aesthetics. Only one or few light sources are required to achieve uniform lighting effect. According to the present disclosure, additional function is given to the common-used hair accessories to significantly enhance the applicability of the hair accessories.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A luminous hair accessory, comprising:
a main body for holding hair, wherein at least a portion of the main body is made of light guide material and has at least one light entrance and at least one light extraction structure, a fixed light path from the light entrance to the light extraction structure being formed in the light guide material; and
a light module coupled to the main body and configured to emit light to the at least one light entrance on the main body, the light traveling over the portion of the main body and being extracted from the portion of the main body through the at least one light extraction structure.

2. The luminous hair accessory according to claim 1, wherein the light guide material is polycarbonate, poly(methyl methacrylate), polystyrene, acrylonitrile butadiene styrene or a combination thereof, the light being guided in the light guide material by total internal reflection.

3. The luminous hair accessory according to claim 1, wherein the light extraction structure comprises embossing, a V-cutting groove or micro dots formed by etching, injection molding or printing.

4. The luminous hair accessory according to claim 1, wherein a notch is formed on the portion of the main body to indicate the light entrance receiving the light from the light module.

5. The luminous hair accessory according to claim 1, wherein the light module is an internal light module to be embedded in the portion of the main body, the internal light module comprising:
a resilient cover defining therein an accommodation space and having an opening connected to the accommodation space;
at least one light source disposed in the accommodation space for emitting the light;
a battery device disposed in the accommodation space for powering the light source; and
a push switch electrically connected between the light source and the battery device and disposed close to a touch surface of the resilient cover for switching on and off the light source in response to a pressing action on the touch surface.

6. The luminous hair accessory according to claim 5, wherein a positioning hole is formed on the portion of the main body for supporting the internal light module.

7. The luminous hair accessory according to claim 1, wherein the light module is an external light module detachably coupled to the main body, the external light module comprising:
a deformable cover defining therein an accommodation space and having an opening connected to the accommodation space, a portion of the deformable cover deforming in response to a pressing action, a securing member being formed on the deformable cover to secure the external light module to the main body;
at least one light source disposed in the accommodation space for emitting the light;
a battery device disposed in the accommodation space for powering the light source; and
a push switch electrically connected between the light source and the battery device and disposed close to the deformed portion of the deformable cover for switching on and off the light source in response to the pressing action.

8. The luminous hair accessory according to claim 7, wherein the main body comprises two handle portions pivotally coupled to each other and the external light module is secured between the two handle portions, wherein the external light module is switched on or off when the handle portions are pressed together in response to the pressing action to open the main body to receive or relieve the hair and squeeze the external light module.

9. The luminous hair accessory according to claim 8, wherein the securing member is an elastic catch loop formed on a lateral surface of the deformable cover wherein the external light module is secured to the main body by fitting the elastic catch loop to one of the handle portions.

10. The luminous hair accessory according to claim 9, wherein a groove is formed on the one handle portion to accommodate a portion of the elastic catch loop when the elastic catch loop is fit to the one handle portion to secure the external light module to the main body.

11. The luminous hair accessory according to claim 7, wherein the pressing action is directly performed on the deformed portion of the deformable cover.

12. The luminous hair accessory according to claim 7, wherein the securing member is a hook and a corresponding catch, a hook and loop fastener or a magnet pair.

13. The luminous hair accessory according to claim 1, wherein the main body comprises:
a hair-sectioning piece to be inserted into hair; and
a hair-clamping piece pivotally coupled to the hair-sectioning piece for cooperating with the hair-sectioning piece for clamping a bundle of hair, the hair-clamping piece being integrally formed and made of the light guide material and has the light entrance and the light extraction structure, wherein the light emitted from the light module enters the hair-clamping piece through the light entrance and is extracted from the hair-clamping piece through the light extraction structure.

14. The luminous hair accessory according to claim 13, wherein the hair-sectioning piece is integrally formed and made of the light guide material and has another light entrance and another light extraction structure, wherein the light emitted from the light module enters the hair-sectioning piece through the another light entrance and is extracted from the hair-sectioning piece through the another light extraction structure.

15. The luminous hair accessory according to claim 1, wherein the main body comprises:
a first clamping piece integrally formed and made of the light guide material and has a first light entrance and a first light extraction structure; and
a second clamping piece integrally formed and made of the light guide material and has a second light entrance and a second light extraction structure, the second clamping piece being pivotally coupled to and cooperating with the first clamping piece for clamping a bundle of hair,
wherein first light emitted from the light module enters the first clamping piece through the first light entrance and is extracted from the first clamping piece through the first light extraction structure; and second light emitted from the light module enters the second clamping piece through the second light entrance and is extracted from the second clamping piece through the second light extraction structure.

16. The luminous hair accessory according to claim 1, wherein the main body comprises a decorative portion not covered by the hair and has thereon at least one positioning hole for supporting at least one light module in a one-to-one manner.

17. The luminous hair accessory according to claim 1, wherein the main body has a form of a hair clip, an alligator hair clip, an arch clip, a butterfly hair clip, a claw clip, a barrette clip, a headband, a teeth comb hairband, a ponytail barrette, an updo barrette, a tortoise shell barrette, a hair comb, a hair stick or a hair tie cuff.
